(19) United States
(12) Patent Application Publication
(10) Pub. No.: US 2026/0328606 A1
(43) Pub. Date: Oct. 22, 2026

(54) Module for measuring a particle flow from an agricultural machine, comprising means for transferring the particles between collection means and measurement means

(71) Applicants: BUREL PRODUCTION, CHATEAUBOURG (FR); KUHN SAS, SAVERNE (FR); Institut National De Recherche Pour L'agriculture L'alimentation Et L'environnement, PARIS (FR)

(72) Inventors: Lionel LEVEILLE, Vitre (FR); Mathieu HAYOT, LA GUERCHE DE BRETAGNE (FR); Emmanuel PIRON, CREUZIER LE VIEUX (FR); Denis MICLET, VARENNES SUR ALLIER (FR); Philippe POTIER, ZITTERSHEIM (FR)

(21) Appl. No.: 19/572,118

(22) Filed: Mar. 19, 2026

(30) Foreign Application Priority Data
Mar. 20, 2025 (FR) 2502845
Mar. 20, 2025 (FR) 2502846

(51) Int. Cl. G01F 3/24; G01F 15/00; G01F 15/18

(52) U.S. Cl. CPC G01F 3/24; G01F 15/006; G01F 15/185

(57) ABSTRACT

A particle-flow measurement module for a test bench that implements at least two measurement modules, wherein the measurement module is intended to be positioned facing at least one outlet mechanism of an agricultural machine for distributing particles in order to receive the entirety of the particles delivered by the at least one outlet mechanism. The measurement module includes a collector for collecting particles from said at least one outlet mechanism of the agricultural machine and measurement device for measuring a quantity of particles from the collector. The measurement module further includes particle transfer device that links the collector to the measurement device. The transfer device is configured to receive the particles flowing in a turbulent manner from the collector and to deliver them in a controlled and regular flow to the measurement device.

### CROSS-REFERENCE TO RELATED APPLICATIONS

This Application claims priority to and the benefit of French Patent Application No. 2502845, filed Mar. 20, 2025, and French Patent Application No. 2502846, filed Mar. 20, 2025, the contents of which are incorporated herein by reference in their entireties.

### TECHNICAL FIELD

The present disclosure relates to the general technical field of agricultural mechanisation.

More specifically, the disclosure relates to the testing of a metering and distribution of particles in the context of precision agriculture. It also relates to the testing of a metering and distribution of powders and liquids.

The disclosure thus applies in particular, but not exclusively, to seed drills that are intended to be mounted on or towed behind a tractor and that allow particles to be delivered over a plurality of rows on a plot of land, for example on a farm. The disclosure also applies to pneumatic fertiliser spreaders.

### PRIOR ART

‘Particles’ is understood here as granular materials, such as seed grains or fertiliser particles or seed-protection particles (e.g. slug repellent) or grains of plant health products.

The case of the distribution of seed grains by a seed drill is considered in more detail in the following. It is clear, however, that the approach of the disclosure can be generalised to other types of particles, in particular to the spreading of solid fertilisers by means of non-centrifugal spreaders, such as a pneumatic fertiliser spreader.

A seed drill generally includes one or more particle storage hoppers that feed a plurality of outlet units, called sowing elements, distributed evenly over the frame of the seed drill transversely to the direction of forward movement of the seed drill when it is hitched to a tractor. The particles from the hopper generally flow through distribution lines to each sowing element in a substantially continuous flow. Each sowing element defines a seeding row or sowing row which substantially coincides with the vertical median plane of the corresponding sowing element, and the distance between two adjacent seeding rows defines the spacing. The seed drill thus allows particles to be delivered over a plurality of rows.

In the context of precision agriculture, it is desirable for the distribution of seeds during seeding operations, i.e. the desired quantity of product per unit of surface-area, to be as even and as precise as possible. It is thus important that the seed drills used by farmers should prevent to the greatest possible extent irregularities such as gaps and doubles, as well as differences between rows. For instance, the recommended density for sowing maize is between 7 and 12 seeds per m², while for sowing wheat it is between 200 and 500 seeds per m².

It is thus necessary to test seed drills during the research and development phases or upon leaving the production line and in particular to verify compliance with the recommended seeding rate—and thus the seeding rate of each sowing element—of the seed drill. The manufacturer can be obliged to test the operating performance, in particular its distributive performance over each row (known as longitudinal distribution) and between the individual rows (known as transverse distribution), for example in connection with environmental standards, as well as possibly to issue a certificate of production conformity.

The standards ISO 7256 or EN 13739, for example, define testing parameters for the testing of the working performance of seed drills and spreaders.

A calibration procedure is thus implemented during the research and development phase, production phase or service phase, during which, in order to ensure a correct setting of the metering mechanisms, the seeds distributed by all or a portion of the sowing elements are collected in a bag or container attached to the corresponding sower. The bag or container is removed and its contents are weighed or counted manually to determine the quantity of seeds distributed, and the seed drill is adjusted as a function of the distributed quantity. The procedure is repeated until the distributed quantity corresponds to the desired value. The need to weigh the contents of each bag and to repeat the calibration procedure several times is time-consuming.

The document EP 1 610 112 discloses a test bench for measuring the spread distribution of distributers of particles to be spread, which involve a centrifugal distribution of the particles by a disc.

The weighing data and angular values are continuously recorded during the test; upon completion of the test, the raw data regarding the distribution on the ground can be processed spatially in order to establish the distribution pattern on the ground.

Another solution, which is disclosed in the document EP 3 135 090, consists in installing a seed-counting sensor along the flow path of the seeds that leads into the sowing units. A drawback of this solution is that these sensors interfere with the performance of the sowing units being measured. Moreover, a saturation phenomenon of the optical sensor occurs, which causes a percentage of measurement error. This error percentage is approximately 2% for wheat, with 98% of the seeds of wheat passing in front of the sensor being counted at a rate of 250 seeds passing in front of the sensor per second.

In addition, the document EP 3 908 097 discloses a spreading machine with a calibration unit that includes an inlet structure for transmitting a product to be spread from a product storage hopper to a metering wheel, a control/regulation device connected to the metering wheel, and a weighing device placed downstream of the metering wheel that can be tilted so as to effect its emptying. This calibration unit allows the actual mass flow of the material to be spread to be regulated but does not allow a flow-rate measurement at the outlet of each outlet mechanism of the machine.

It is also desirable to test the seed drills in the field, as the actual output of the essentially continuous stream of product can differ considerably from the desired output after several hours of use of the seed drill.

There is thus a need for a simple, reliable, easy-to-use and reasonably priced solution for a constant determination of the values of quantities of particles distributed by each sowing element of a seed drill, or more generally of a machine with particle outlet mechanisms, in order to describe its distribution performance over each row (known as the longitudinal distribution) and between the individual rows (known as the transverse distribution).

There is also a need for a solution which is adaptable to as many sowing elements available on the market as possible and which does not interfere with the elements of the machine.

There is also a need for a solution which can handle the heterogeneity of the particles used in the field of sowing and which is adaptable to the different sizes, speeds and trajectories of particles delivered by the sowing elements.

There is additionally a need for a solution which makes it possible to reduce the time needed to set or calibrate agricultural machinery and to make this tests less onerous for operators.

### SUMMARY

An exemplary aspect of the present disclosure relates to a particle-flow measurement module for a test bench that implements at least two measurement modules, wherein said measurement module is intended to be positioned facing at least one outlet mechanism of an agricultural machine for distributing particles so as to receive the entirety of the particles delivered by said at least one outlet mechanism, wherein said measurement module includes collection means for collecting particles from said at least one outlet mechanism of the agricultural machine and measurement means for measuring a quantity of particles from the collection means, wherein said measurement module further includes particle transfer means that link the collection means to said measurement means, wherein said transfer means are configured to receive the particles flowing in a turbulent manner from the collection means and to deliver them in a controlled and regular flow into the measurement means.

An exemplary aspect of the present disclosure thus proposes a particle-flow measurement module which is intended to be placed opposite one or more outlet mechanisms of an agricultural machine and which makes it possible to receive/collect all particles distributed by said one or more outlet mechanisms, by being located as close as possible to the latter, and to measure a quantity of particles in a continuous or virtually continuous manner.

One or more outlet mechanisms of an agricultural machine can be arranged above the collection means of a measurement module or can be arranged at least partially in the collection means of the module.

Each outlet mechanism can be a sowing element of a seed drill, such as a single-seed sowing element, or an outlet conduit of a pneumatic fertiliser spreader.

An aspect of the disclosure proposes to arrange, between the collection means and the measurement means, transfer means which make it possible to effect the equivalent of a discretisation of the continuous flow of particles from the collection means.

This continuous flow of particles from one or more outlet mechanisms (sowing elements in the case of a seed drill), which flow in a turbulent flow that may contain air and thus involve a certain level of pressure and/or velocity, falls into the collection means. This is understood in the sense that the particles flow at a relatively high speed and in a chaotic or disordered manner, with different trajectories, along the collection means and flow towards the transfer means with considerable energy.

These transfer means, which isolate or separate the two spaces for collecting and for measuring the particles, enable a regular passage and a controlled flow of the particles into the measurement means. In other words, the transfer means are designed to absorb and reduce the energy and the velocity of the particles flowing from the collection means and to discharge them into the measurement means at a lower velocity and with a reduced energy, in a same direction, and at a lower pressure if the incoming flow of particles contains air.

The measurement of a quantity of particles is thus not distorted by the impacts of the particles that would otherwise enter the measurement means at a high speed and with considerable energy. An air flow can in fact interfere with the stabilisation of the weight on precision scales, which impairs the responsiveness of the weight measurement. Seeds arriving too quickly would also interfere with the measurement. As a result of the fact that the flow entering the measurement means is controlled—i.e. is directed, channelled and has a reduced speed—the measurement of a quantity of particles is more accurate and responsive and is not disturbed by a potential air flow present in the flow of particles upstream of the transfer means.

A more accurate and rapid measurement of a quantity of particles is thus obtained.

In a particular embodiment, this measurement module makes it possible to weigh the particles delivered by one or more outlets. The module is configured to provide a weight measurement, for example for the determination of the particle flow rate (dP/dT) delivered by at least one sowing element of an agricultural machine of a seed drill type. Such an implementation makes it possible to limit the number of operations to be carried out by a user, in particular by eliminating the need to take the collection container elsewhere to weigh it.

The module, which is portable, is not intrusive for the agricultural machine (e.g. a seed drill) and its outlet mechanisms (the sowing elements in this scenario) and does not interfere with the performance of the outlet mechanisms that one is trying to measure.

The measurement module is designed to be used alone or with other identical modules on a test bench in such a manner that the measurements of each module can be synchronised so as to determine the performance of the machine. The object of the test bench is to test and carry out verifications of the operation of an assembled seed drill that has just left the production line and that is in particular ready to be used by an operator for planting.

The measurement module can be taken to a field, for example with a means of transport such as a van, in order to measure individually the performance of the outlet mechanisms of an agricultural machine after several hours of use in the field and to detect any anomalies affecting one or more of these outlet mechanisms. To this end, it can be necessary to make adjustments to accommodate the measurement module, which in particular consist in raising the seed drill and disconnecting and diverting the seed transport pipes.

According to a first embodiment of the disclosure, the transfer means take the form of a rotary gate that includes a plurality of blades that define cells for transporting particles.

According to a further particular feature of at least one embodiment of the disclosure, the blades of said gate are made of a flexible material.

Preferably, the blades of said gate are made of polyurethane with a hardness of between 50 and 90 Shore, preferably between 60 and 80 Shore, preferably 70 Shore.

According to a further particular feature of at least one embodiment of the disclosure, the measurement module includes control means for controlling the rotational speed of the rotary gate.

According to a particular implementation of at least one embodiment of the disclosure, the rotary gate includes a rotor and at least six transport cells for transporting particles, wherein the blades of at least two cells are in contact with the stator of the gate during the rotation of the latter.

Preferably, the volume of a transport cell is between 8 and 15 cm³ and is preferably approximately 11 cm³.

According to a second embodiment of the disclosure, the transfer means take the form of a hollow element that includes an internal space for receiving particles, wherein said internal space includes a particle inlet opening at one end that is capable of collecting particles from the collection means and an outlet opening at the opposite end that is capable of delivering the particles to the measurement means, wherein the hollow element is configured to move between a shutting position that shuts the outlet opening, in which the particles from the collection means are received in the internal space, and a release position that opens the outlet opening so as to release the particles accumulated in the internal space to the measurement means.

According to a particular implementation of this second embodiment of the disclosure, the walls of the hollow element are made of a flexible material and are capable of deforming so as to shut or open the outlet opening.

According to a particular feature of at least one embodiment of the disclosure, said collection means include a collection receptacle for collecting particles, which includes a particle inlet opening with a first cross section that is capable of collecting particles from said at least one outlet mechanism of the agricultural machine and an outlet opening with a second cross section that is smaller than the first cross section, wherein the second outlet opening is capable of delivering the particles to the measurement means for measuring a quantity of particles, wherein the walls of the collection receptacle are configured to guide the particles from the inlet opening towards the outlet opening.

According to a further particular feature of at least one embodiment of the disclosure, at least one sensor for sensing passing particles is provided, such as an optical fork sensor, which is arranged at the inlet opening of the receptacle for collecting particles.

Also proposed is an unclaimed embodiment of a particle-flow measurement module for a test bench that implements at least two measurement modules, wherein said measurement module is intended to be positioned facing at least one outlet mechanism of an agricultural machine for distributing particles in order to receive the entirety of the particles delivered by said at least one outlet mechanism, wherein said measurement module includes first means for collecting particles from said at least one outlet mechanism of the agricultural machine and second means for measuring a quantity of particles received, wherein the first collection means are capable of delivering the collected particles to the second measurement means.

A particle-flow measurement module is thus proposed which is intended to be positioned opposite one or more outlet mechanisms of an agricultural machine and which makes it possible to receive/collect all particles distributed by said one or more outlet mechanisms, by being located as close as possible to the latter, and to measure a quantity of particles in a continuous or virtually continuous manner.

This measurement module successively includes collection means configured to collect the totality of the particles distributed by one or more outlet mechanisms and measurement means separate from the collection means, so that the collection of the particles exiting the one or more outlet mechanisms of the agricultural machine does not interfere with measurement and so that the measurement is as fast and as accurate as possible.

The particles in fact flow out of the one or more outlet mechanisms in a turbulent flow and have a relatively high velocity and energy, as well as varied trajectories, which can be directed and channelled towards the weighing means at a lower velocity and with a reduced energy with the collection means.

The measurement of a quantity of particles is thus not distorted by the impacts of the particles that would otherwise enter the measurement means at a high speed and with considerable energy. Seeds that arrive too fast can in fact interfere with the stabilisation of the weight on precision scales, which impairs the responsiveness of the weight measurement. A more accurate and rapid measurement of a quantity of particles is thus obtained.

One or more outlet mechanisms of an agricultural machine can be arranged above the collection means of a measurement module or can be arranged at least in partially in the collection means.

This measurement module can be used on its own to measure the performance of the different outlet mechanisms of an agricultural machine individually.

Each outlet mechanism can be a sowing element of a seed drill, such as a single-seed sowing element, or an outlet conduit of a pneumatic fertiliser spreader.

It can be implemented on a test bench in combination with other modules of the same type in such a manner that it is possible to synchronise the measurements of each module and determine the performance of the machine.

The object of the test bench is to test and carry out verifications of the operation of an assembled seed drill that has just left the production line and that is in particular ready to be used by an operator for planting.

By way of example, this measurement module makes it possible to weigh the particles delivered by one or more outlet mechanisms of the agricultural machine. The module is configured to provide a weight measurement, for example for the determination of the particle flow rate (dP/dT) delivered by at least one sowing element of an agricultural machine of a seed drill type. Such an implementation makes it possible to limit the number of operations to be carried out by a user, in particular by eliminating the need to take the collection container elsewhere to weigh it.

The module, which is portable, is not intrusive for the agricultural machine, e.g. a seed drill, or its outlet mechanisms (the sowing elements in this scenario) and does not interfere with the performance of the outlet mechanisms that one is trying to measure.

The measurement module can be moved to perform measurements on site, for example in a field, with a means of transport such as a van in order to measure the performance of the seed drill after several hours of use in the field and to detect any anomalies affecting one or more sowing elements of the seed drill. To this end, it can be necessary to make adjustments to accommodate the measurement module, which in particular consist in raising the seed drill and disconnecting and diverting the seed transport pipes.

Further features of this unclaimed measurement module are described in the following.

Said collection means can include a collection receptacle for collecting particles, which includes a particle inlet opening with a first cross section that is capable of collecting particles from said at least one outlet mechanism of the agricultural machine and an outlet opening with a second cross section that is smaller than the first cross section, wherein the second outlet opening is capable of delivering the particles to the measurement means for measuring a quantity of particles, wherein the walls of the collection receptacle are configured to guide the particles from the inlet opening towards the outlet opening.

The walls of the collection receptacle are thus configured to channel the particles from the inlet opening towards the outlet opening.

The ratio between the first and second cross sections can be between 3:1 and 12:1 and is preferably essentially equal to 8:1.

The collection receptacle can have a general shape of a funnel, the cross section of which decreases progressively from the particle inlet opening to the particle outlet opening.

The inlet opening of the collection receptacle can have an essentially rectangular cross section.

This inlet opening can have a rectangular cross section or can have an oval cross section or a cross section in the shape of a very elongated ellipse with a length-to-width ratio essentially equal to 8:1.

The length of the inlet opening is measured in the direction of forward movement of the agricultural machine and the width of the inlet opening is measured in the direction transverse to this direction of forward movement.

The collection receptacle can include an internal space defined by at least one peripheral wall that includes a portion that forms a ramp directed towards the outlet opening.

The collection receptacle can include two opposite longitudinal walls connected to each other by a side wall and a bottom wall that includes said portion forming a ramp.

The bottom wall can include a plurality of portions including a portion that forms a ramp.

The angle of inclination of said portion of the bottom wall that forms a ramp can be less than the angle of inclination of the longitudinal walls and said side wall.

Said side wall can be curved.

The radius of curvature of said curved side wall can be between 1 and 6 m, preferably between 2 and 4 m.

At least a part of said at least one peripheral wall can be made of a flexible material.

Said at least one part of said at least one peripheral wall can consist of at least one flexible element with undulating folds.

As a result of the folds, which resemble the folds of a curtain or an accordion, the surface of the flexible element has undulations in order to absorb the energy of the particles even more effectively.

Said at least one peripheral wall of the collection receptacle can include micro-perforations for the passage of air.

When the particles discharged by an outlet mechanism of the agricultural machine enter the collection means mixed with the air conveying the particles, these micro-perforations allow this conveying air to be let out. Separating the air from the particles prior to the measurement (e.g. of the weight) of these particles makes it possible to improve the reliability of the measurement. These micro-perforations are obviously dimensioned so as to keep the particles in the collection means.

The micro-perforations can be essentially square and preferably have a length between 0.3 and 0.6 mm.

The measurement module can include tilting means for tilting the measurement means from a position for receiving a quantity of particles from the collection means to a position for emptying said measurement means.

The measurement means for measuring a quantity of received particles can belong to the group including:
particle-weighing means, such as a dynamic weighing sensor;
particle-counting means, such as an optical sensor,
means for measuring a volume of a batch of particles, such as a flowmeter with a paddle wheel.

### LIST OF FIGURES

Other features and advantages of the disclosure will become apparent from a perusal of the following description of embodiments—which is given as a simple, illustrative and non-limiting example—and the attached drawings, wherein:

FIG. 1 is a side view of a measurement module according to one embodiment of the disclosure;

FIG. 2 is a perspective view of the measurement module of FIG. 1 with a transparent view of the transfer means in the form of a rotary gate;

FIG. 3 is a cross-sectional view of the measurement module of FIG. 1;

FIG. 4A illustrates very schematically another example of transfer means implemented in a measurement module in accordance with the disclosure in a first position;

FIG. 4B shows the transfer means of FIG. 4A in a second position;

FIG. 5A illustrates a further example of transfer means implemented in a measurement module in accordance with the disclosure in a first position;

FIG. 5B shows the transfer means of FIG. 5A in a second position;

FIG. 6 is a flowchart showing the different successive operations of collecting, transferring and weighing carried out by a measurement module according to the disclosure;

FIG. 7 is a side view of a measurement module according to an unclaimed embodiment;

FIG. 8 is a perspective view of the measurement module of FIG. 7;

FIG. 9 is a flowchart showing the different successive operations of collecting and weighing carried out by the measurement module of FIGS. 7 and 8.

### DESCRIPTION OF EMBODIMENTS

The following discussion focuses primarily on row-crop or single-seed seed drills capable of delivering granular materials, such as seed grains, fertiliser particles, seed-protection particles (e.g. slug repellent) or grains of plant health products.

Such seed drills can be mounted or towed.

The same explanations and comments also apply to other agricultural machines for distributing particles which include one or more particle outlet mechanisms.

Seed drills generally come equipped with a hopper designed to hold the seed grains, a specific distribution system—for example a pneumatic, gravity-fed or mechanical system with a conveyor, belt or brush—and planting mechanisms or sowing elements which are generally identical and mounted so as to be parallel to one another on a seed drill frame, each defining a sowing row. Each sowing element is capable of planting seeds, as well as an associated fertiliser where applicable, into the soil so as to obtain a regular spacing over the corresponding sowing row.

A seed drill thus makes it possible to sow seeds in regularly spaced rows, i.e. over a plurality of lines or rows (36 or 48 rows, for example), at an adjustable depth and with a certain density, which is regulated by distributing mechanisms.

### Description of a Particular Embodiment of the Disclosure

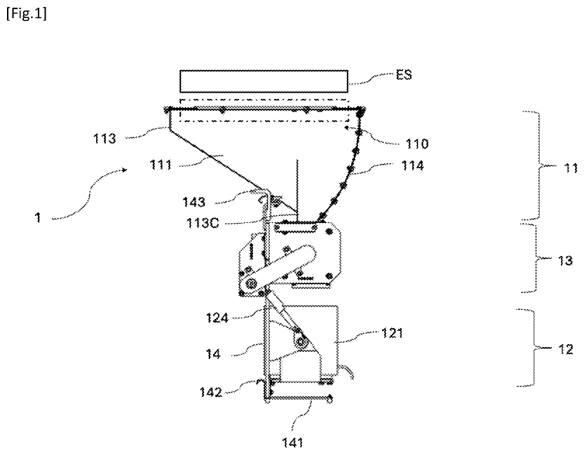

FIGS. 1 to 3 illustrate a particle-flow measurement module according to one embodiment of the disclosure.

Such a measurement module is, for example, intended to be implemented with other identical modules for the constant determination of the values of quantities of particles distributed by each sowing element of a seed drill, given that the particles generally flow through the distribution lines to each sowing element in an essentially continuous stream. The measurement module is always positioned at the outlet or end of the sowing element ES, i.e. at the coulter.

The measurement module 1 successively includes collection means 11 for collecting particles from a sowing element ES (illustrated schematically as a rectangle) of a seed drill in a sowing position and measurement means 12 for measuring a quantity of particles from the collection means 11. The assembly is mounted on an L-shaped frame 14 with two support legs 141. The frame further includes coupling means (hooks 142 and clamps 143 in the illustrated example) for coupling the measurement module 1 to a test bench (not shown) which enable a rapid installation and positional adjustment of the measurement module 1 as well as an easy uncoupling.

In FIG. 1, the sowing element ES is located slightly above the collection means 11 but it could be located at least partially in the internal space of the collection means 11, as represented by the dash-dotted line in FIG. 1.

It is noted that the particles arriving from the sowing element ES and falling into the collection means 11 can be mixed with conveying or transport air.

In another scenario, these particles can fall by gravity, without being mixed with air, with moderate energy and a moderate velocity.

In yet another scenario, in a single-seed drill with, for example, a particle transport via a brush belt, these particles can fall into the collection means 11 in an accelerated manner but without air, in this case with a high velocity and energy.

In a variant not shown, the frame has no support legs but is provided, e.g., with a gripping handle. In this scenario, it is not necessary to set the measurement module on the ground during a test, e.g., in a field, as the measurement module can be attached to the agricultural machine to be tested by suitable attachment means.

The measurement module 1 further includes transfer means 13 for transferring particles from the collection means 11 to the measurement means 12, which are located underneath the collection means 11 and which are configured to slow down the particles arriving from the collection means 11 and to deliver them in a controlled and regular manner into the measurement means 12.

In the illustrated example, the collection means 11 include a collection receptacle 110 for collecting particles that includes an internal space defined by at least one peripheral wall and that includes a portion that forms a ramp directed towards the outlet opening.

In the illustrated example, the collection receptacle 110 includes two opposite longitudinal walls 111, 112 connected to each other by a side wall 114 and a bottom wall 113 that are arranged facing each other.

The collection receptacle 110 also includes a particle inlet opening 116 with a first cross section that is capable of collecting particles from the sowing element ES of the agricultural machine without the receptacle being in contact with the sowing element, as well as an outlet opening 117 with a second cross section that is smaller than the first cross section, wherein the outlet opening 117 is capable of delivering the collected particles to the particle transfer means 13.

In the illustrated example, the bottom wall 113 includes a first flat portion 113A located on the side of the inlet opening 116 and which is extended by a second portion 113B that forms a ramp, which is turn extended by a third flat portion 113C located on the side of the outlet opening 117.

By way of example, the ratio between the first cross section of the inlet opening 116 and the second cross section of the outlet opening 117 is between 3:1 and 12:1 and is preferably approximately 8:1.

Such a ratio offers several advantages. It advantageously makes it possible for the collection receptacle to be fed with particles from a plurality of separate metering units or sowing elements associated with one or more hoppers of the agricultural machine. It is thus possible to feed the measurement module simultaneously with a plurality of granular materials to be sown, for example field beans, rapeseed and fertiliser. The large opening also makes it possible to collect all the seeds, which arrive in a turbulent and disordered manner, like a funnel that has a wide enough inlet so as to catch all the seeds.

The measurement module is arranged so that the length of the inlet opening 116 corresponds to the direction of forward movement of the agricultural machine and the width of the inlet opening 116 corresponds to the direction transverse to this direction of forward movement.

The inlet opening 116 of the collection receptacle 110 has a rectangular cross section here and allows the module to be adapted to different types of sowing elements. A large opening at the top of the collection receptacle 110 enables an adaptation to a maximum range of outlet mechanisms, such as sowing elements, available on the market as well as to the particle flow without modifying the machine settings recommended by the manufacturer, and makes it possible to receive a plurality of outlets of identical or different particles.

The collection receptacle 110 here has a general shape of a funnel, the cross section of which decreases progressively from the particle inlet opening 116 to the particle outlet opening 117. The two opposite longitudinal walls 111, 112 do not extend parallel to each other in the illustrated example but become gradually closer as one moves from the inlet opening 116 towards the outlet opening 117.

The second portion 113B of the bottom wall 113 of the collection receptacle 110 in this example forms a ramp directed towards the outlet opening 117. The angle of inclination of this ramp is less than the angle of inclination of the longitudinal walls 111, 112 and the side wall 114.

The side wall 114 of the collection receptacle 110 has a curved shape here, while the longitudinal walls 111, 112 are flat. This curved shape of the side wall 114 allows the flow of particles exiting the sowing element ES to be directed downwards despite the ejection angle specific to each sowing element. It enables an absorption of the kinetic energy of the particles falling onto this curved side wall 114.

In a variant not shown, the side wall 114 of the collection receptacle 110 is flat.

The radius of curvature of the curved side wall 114 is between 1 and 6 m, preferably between 2 and 4 m, for example 3 m.

The walls of the collection receptacle 110 are configured to channel or guide the flow of particles from the inlet opening 116 towards the outlet opening 117 that communicates with the particle transfer means 13.

The measurement means 12 for measuring a quantity of particles from the collection means 11 belong to the group including:
particle-weighing means, such as a dynamic weighing sensor;
particle-counting means, such as an optical sensor,
means for measuring a volume of a number of particles, such as a flowmeter with a paddle wheel.

In the illustrated example, the measurement means 12 for measuring a quantity of particles include a weighing container 121 and a weighing sensor 122 that is arranged under the weighing container 121 and that is capable of weighing the particles received in the weighing container 121. This enables a precise measurement of a quantity of particles.

In the illustrated example, the weighing container 121 is cuboid in shape. It includes an upper opening 123 capable of collecting particles from the collection receptacle 110 via the particle transfer means 13. The particles fall by gravity into the weighing container 121. The upper opening 123 extends essentially underneath the outlet opening of the transfer means 13, wherein the gap between these two openings is small so that the measurement module is compact in height. The upper opening 123 of the weighing container 121 is larger than the outlet opening of the transfer means 13.

This measurement module 1, which is portable, can also be used in an autonomous manner to take measurements in the field. In this use case, there is no test bench, but the measurement module 1 is used directly in the field.

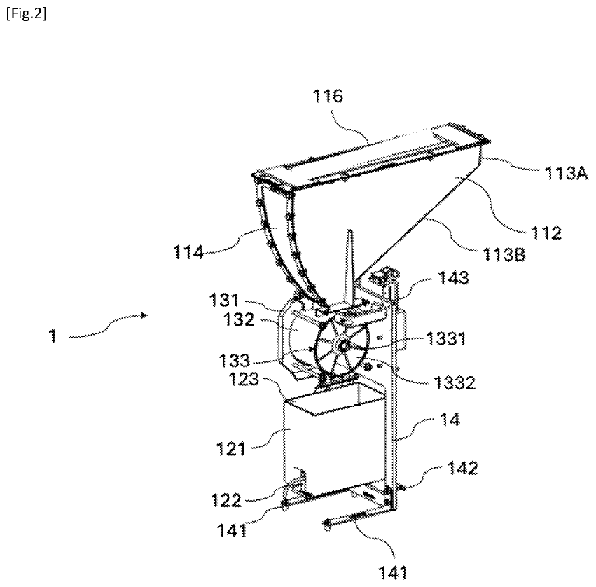

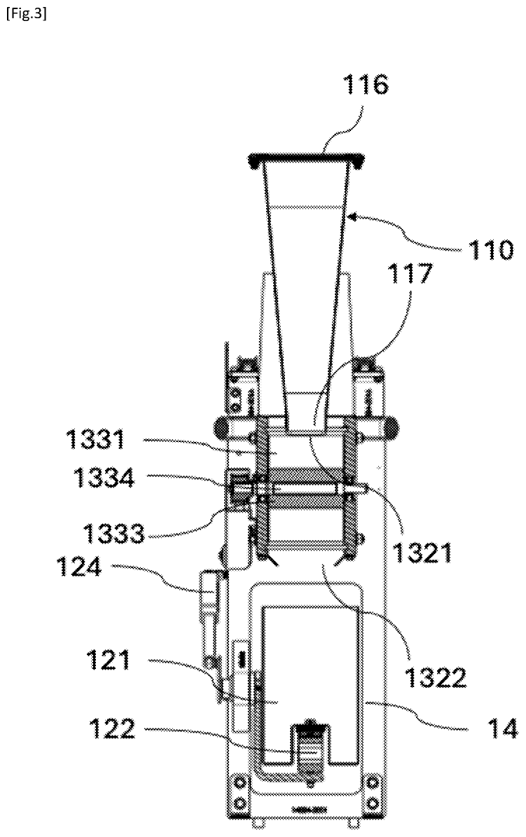

In the illustrated example, as shown in FIGS. 2 and 3, the transfer means 13 include a housing 131 that is cuboid in shape, inside which a cylindrical chamber 132 (also called a stator) is arranged, inside which a rotary gate is mounted. This rotary gate 133 includes a plurality of blades 1331 that define cells or cavities 1332 for receiving and transporting particles from the collection means 11 to the measurement means 12. The blades 1331 are distributed around a rotor 1333 which can be rotated around a drive shaft 1334. The document EP 3 766 325 describes such a rotary gate.

The rotor 1333 can be, for example, rotated by means of a motor that comes with an electrical control unit for controlling this motor. Power transmission can occur via a belt.

According to one possible implementation, the measurement module includes control means for controlling the rotational speed of the rotor 1333. The rotational speed of the latter can be a function of the air presence in the particle flow entering the gate, the type of product being measured, or the theoretical dose of product to be measured, for example.

In the illustrated example, the measurement module 1 includes a gear motor 134 capable of rotating the rotor 1333, which has the advantage of being compact.

According to one possible embodiment, the blades 1331 of the gate 133 are made of a flexible material.

Compared to rigid blades, the contact pressure between the blades 1331 and the inner wall of the cylindrical chamber 132 (or stator) is reduced. This makes it possible to generate a lower stress so that the drive torque can be reduced compared to a scenario in which rigid blades are used.

In the described embodiment, the blades 1331 are made of polyurethane, with a hardness of between 50 and 90 Shore, preferably between 60 and 80 Shore, preferably 70 Shore. However, in a variant of this embodiment, it would also be possible to provide blades made of another material, for example rubber or some other elastomer material. The blades 1331 described here have a maximum thickness essentially equal to 3 mm.

The cylindrical chamber 132 includes a particle entry opening 1321 capable of receiving particles from the collection means 11 and an exit opening 1322 capable of delivering the particles exiting the gate device 133 into the measurement means 13.

The gate device 133 is arranged upstream of the measurement means 13 and downstream of the collection means 11, directly in the flow path of the particles exiting the collection means 11, wherein the seeds fall by gravity into the cavities 1332 in the gate 133 as the cavities 1332 rotate. The seeds transported by the cavities 1332 are then discharged by gravity into the weighing container 121 as the cavities 1332 in the gate 133 rotate. In other words, the cavities 1332 make it possible for the particles arriving from the collection means 11 to be received one by one and then discharged in a controlled and regular manner into the measurement means 12 under the action of gravity.

The collection means 11, the inlet opening 1321 and the outlet opening 1322 of the gate 133 are arranged so that the particles follow the path formed by these elements by gravity.

The assembly constituted by the collection means 11, the transfer means 13 and the weighing means 12 is compact due to the relative arrangement of these three elements.

The volume of a cavity 1332 is preferably between 8 and 15cm³ , preferably essentially equal to 11 cm³, and is chosen according to the velocities and seed flow rates to be measured.

In this example, the gate 133 includes eight cavities 1332. It should be noted that the number of blades of the gate 133, and thus the number of cavities, is in particular a function of the desired weighing frequency.

Preferably, the gate 133 includes at least six cavities, wherein the blades of two cavities are in contact with the stator during the rotation of the gate.

During its rotation, the gate 133 feeds the weighing container 121 and the weighing of the particles received in the weighing container 121 is initiated when the gate 133 stops rotating. The weighing sensor 122 emits a weight measurement signal, which is processed either locally by a processing unit included in the measurement module or remotely, for example in a test bench (the processing unit can be configured to obtain a mass flow-rate signal via a time derivative of a weight measurement from the measurement module).

Such an arrangement allows particles with different velocities, trajectories and energies (i.e. flowing in a turbulent manner) to be received in the gate and delivered in a controlled and regular manner to the measurement means 12. The particles thus fall vertically in a same direction into the measurement means 12 at a lower velocity and with less energy.

The implementation of a rotary gate is advantageous in that it can adapt to different particle sizes, velocities and trajectories and is capable of transferring different types of seeds, in particular rapeseed and field beans, at very different flow rates, from 2 to 250 seeds per second, for example.

The rotary gate 133 can make it possible to neutralise the air flow exiting the sowing elements so as to enable a more accurate weighing operation. In other words, the rotary gate 133 makes it possible to separate the air from the flow of particles exiting the sowing elements in order to enable a more precise measurement of a quantity of particles (e.g. a weight measurement) without interference from the air flow.

The measurement module is compact in width (less than 20 cm) and length (less than 50 cm), which makes it possible to measure the performance of agricultural machinery like seed drills with narrow clearances. It further has a reasonable weight of around 10 kg. This measurement module 1 is thus easy to use and move in order to carry out a test.

In a particular embodiment, at least part of the peripheral wall is made of a flexible material. In the described embodiment, the curved side wall 114 is made of such a flexible material.

By way of example, the side wall 114 can consist of a net or woven material that has been folded so as to form an undulating surface which makes it possible to cushion the particles and to minimise rebounds of particles (anti-rebound wall) exiting the sowing element. This curved side wall 114 is preferably a wall with a steep slope so as not to impede the flow of the particles towards the bottom of the collection receptacle 110.

When the side wall 114 consists of a net, any conveying air present in the flow of particles from the sowing element ES into the collection means 11 can be let out through the mesh of the net, so as not to distort the measurement of the quantity of seeds implemented by the measurement means 12 located downstream of the collection means 11. The mesh of the net is dimensioned so as to keep in the particles and let out the conveying air mixed with the particles.

More generally, at least part of the peripheral wall of the collection receptacle 110 can consist of at least one flexible element capable of absorbing the energy of the particles.

The wall can have an undulating shape or be folded like an accordion so as to better absorb the energy of the particles and cushion the latter.

Advantageously, at least one peripheral wall of the collection receptacle 110 can include micro-perforations for the passage of air.

These micro-perforations can correspond to the holes formed by the mesh of a net blocking an opening provided in said at least one peripheral wall.

The micro-perforations can be essentially square and preferably have a length between 0.3 and 0.6 mm.

When the particles exiting an outlet mechanism of the agricultural machine enter the collection means mixed with air conveying the particles, these micro-perforations allow this conveying air to be let out. Separating the air from the particles prior to the measurement (e.g. of the weight) of these particles makes it possible to ensure the reliability of this measurement. These micro-perforations are naturally dimensioned so as to keep the particles in the collection means.

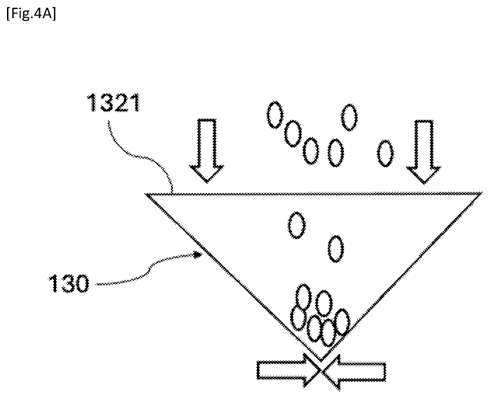

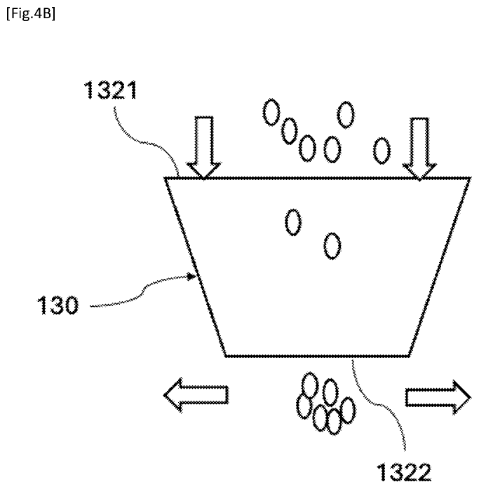

In another embodiment illustrated in FIGS. 4A and 4B, the transfer means 13 take the form of a hollow element or valve 130 that includes an internal space for receiving particles from the collection means 11.

The hollow element or valve 130 includes a particle inlet opening 1321 at one end that is capable of collecting particles from the collection means 11 and an outlet opening 1322 at the opposite end that is capable of delivering the particles to the measurement means 12.

The hollow element or valve 130 is configured to move between a shutting position that shuts the outlet opening 1322 (FIG. 4A), in which the particles from the collection means 11 are received in the internal space of the hollow element, and a release position that opens the outlet opening 1322 (FIG. 4B) so as to release the particles accumulated in the internal space of the hollow element into the measurement means 12.

Similarly, the valve 130 receives particles with different velocities, trajectories and energies (i.e. flowing in a turbulent manner) in the shutting position shown in FIG. 4A and delivers them in a controlled and regular manner to the measurement means 12 in the release position shown in FIG. 4B. The particles thus fall vertically in a same direction into the measurement means 12 at a lower velocity and with less energy.

Advantageously, the walls of the hollow element are made of a flexible material capable of deforming so as to shut or open the outlet opening 1322. The hollow element or valve 130 is preferably pressure-operated. An example of such a valve is disclosed in the document EP 3 659 417.

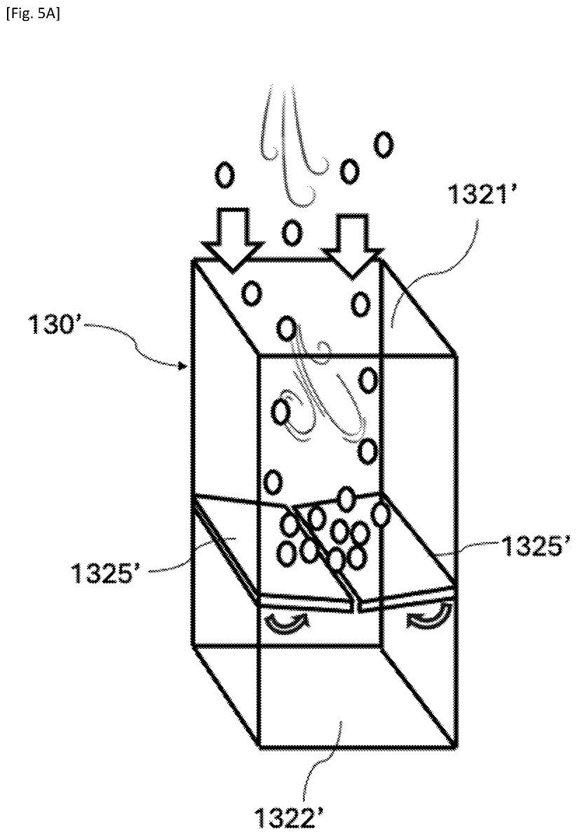

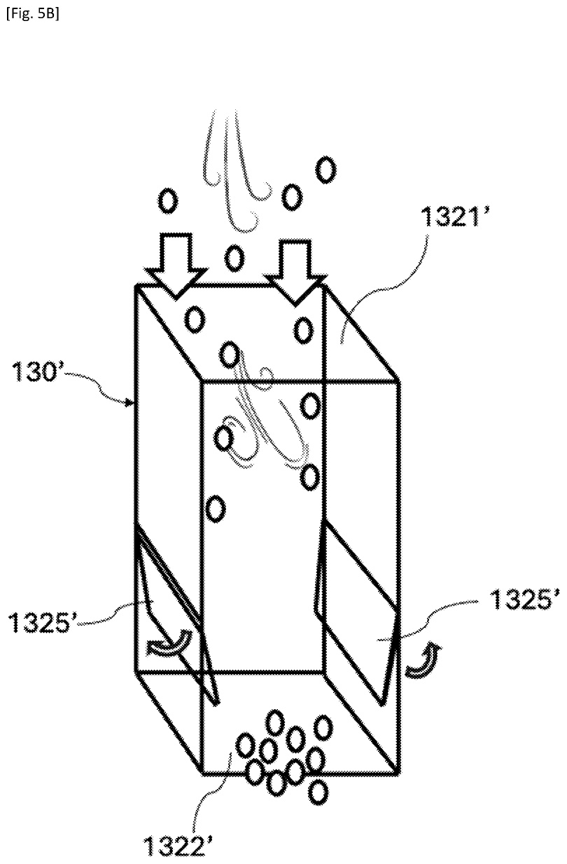

In a variant embodiment, one or more movable closing elements could shut or open the outlet opening of such a valve. Thus, in the example illustrated in FIGS. 5A and 5B, the transfer means 13 take the form of a hollow element 130′ that includes an internal space for receiving particles from the collection means 11. The hollow element 130′ includes a particle inlet opening 1321′ at one end that is capable of collecting particles from the collection means 11 and an outlet opening 1322′ at the opposite end that is capable of delivering the particles to the measurement means 12. The outlet opening 1322′ is shut or opened by two movable flaps 1325′. When these flaps 1325′ are in a closed position, the particles are received in the hollow element 130′. When the flaps 1325′ pivot from their closed position to their open position, the particles collected in the hollow element 130′ can flow towards the measurement means 12. The hollow element 130′ thus delivers the particles in a controlled and regular flow into the measurement means 12.

The transfer means thus perform a particle-transporting function, as in the case of the rotary gate, or a particle-transmitting function, without a transportation, as in the case of the valve described in the forgoing (FIGS. 4A to 5B), or else with a zigzagging particle-transmitting circuit, preferably at a high frequency.

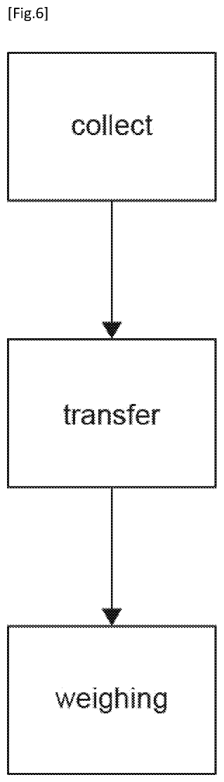

The three successive operations performed by a measurement module according to the disclosure are shown in the flowchart shown in FIG. 6.

In the illustrated example, the measurement module 1 includes tilting means 124 (a cylinder in this example) for tilting the particle-weighing container 121 from a collection position to an emptying position for emptying the weighing container 121. This makes it easy at the end of the weighing operation to empty the weighing container 121 and carry out another measurement if necessary. The weight measurement is interrupted during emptying. Thanks to the cylinder-type tilting means, the weighing container 121 can be emptied remotely (without the intervention of an operator) and according to a procedure that can be automatic.

It is possible to place a plurality of measurement modules side by side and to associate each with one or more sowing elements of a seed drill, and to synchronise the weight measurements of a plurality of measurement modules in order to measure the transverse distribution in lines or rows of the seed drill across the working width and to establish a performance diagnosis for a seed drill just off the production line or in the field after several hours of use. The measurements of quantities emitted by the measurement sensors of each module can be transmitted to a processing device separate from the measurement modules, wherein the processing device can determine a quantity (e.g. weight) of seeds for each of the rows and compare a measured quantity with a theoretical quantity of seeds to be sown for one or more given rows of the seed drill. This makes it possible to verify that each sowing element of the seed drill is functioning correctly and to detect any anomalies or malfunctions affecting one or more sowing elements of the seed drill. This anomaly can be linked to a partial or complete blockage of the sowing element, which requires the intervention of an operator.

The measurement module is suitable for measuring quantities of seeds of different sizes and shapes, for example elongated seeds such as barley, oats or wheat; small, elongated seeds such as flax; or small, round seeds such as rapeseed.

Other variants are described in the following that are not illustrated.

The collection receptacle and the weighing container of the measurement module can be of any other shape.

The collection receptacle 110 can have a general shape of a truncated cone, the cross section of which decreases gradually from the particle inlet opening 116 to the particle outlet opening 117.

The collection receptacle 110 can have an upper portion that has a general shape of a truncated cone and a lower portion that has a general shape of a cylinder.

The walls of the collection receptacle 110 are configured to channel or guide the flow of particles from the inlet opening 116 towards the outlet opening 117 that communicates with the measurement means 12.

The measurement module can include at least one sensor for sensing passing particles, such as an optical fork sensor, which is arranged at the inlet opening 116 of the receptacle 110 for collecting particles, which makes it possible to carry out a measurement of the longitudinal distribution of particles exiting the one or more the corresponding sowing elements.

The measurement means can take the form of a measuring container with a general shape of a truncated cone.

Although the measurement module has been described for a seed drill, it is evident that the same approach can be applied to other agricultural machinery.

The measurement module is suitable in particular, but not exclusively, for measuring the performance of pneumatic and mechanical seed drills. It is also suitable for measuring the performance of pneumatic fertiliser spreaders which include, in a known manner, a boom equipped with a plurality of outlet mechanisms that take the form of outlet conduits or pipes distributed along this boom and that take the form of outlet conduits or pipes that can be equipped with diffusers or spreader paddles.

It is, however, not suitable for measuring the performance of centrifugal spreaders.

It is again noted more generally that the invention is not limited to the described and illustrated examples.

### Description of an Unclaimed Embodiment

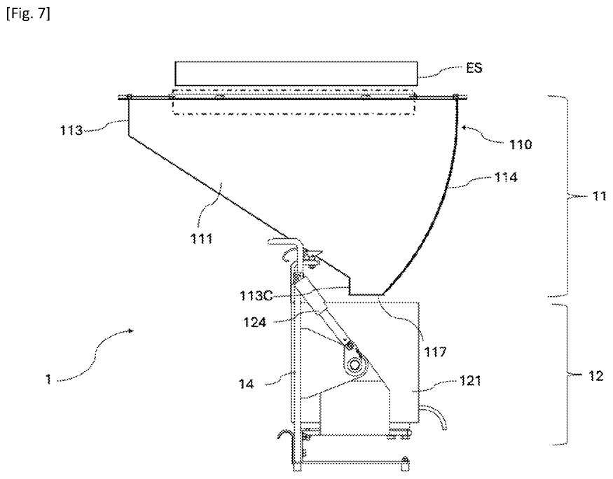

An embodiment of an unclaimed particle-flow measurement module is described with reference to FIGS. 7 to 9.

Such a measurement module is, for example, intended to be implemented with other identical modules for the constant determination of the values of the quantities of particles distributed by each sowing element ES of a seed drill, given that the particles generally flow through the distribution lines to each sowing element ES in an essentially continuous stream. The measurement module is always positioned at the outlet or end of the sowing element ES, i.e. at the coulter.

The measurement module 1 successively includes collection means 11 for collecting particles from a sowing element ES (illustrated schematically by a rectangle in FIG. 7) of a seed drill in a sowing position and measurement means 12 for measuring a quantity of particles from the collection means 11. These two successive operations performed by the measurement module are represented in the flowchart in FIG. 9. The assembly is mounted on an L-shaped frame 14 with two support legs 141. The frame further includes coupling means (hooks 142 and clamps 143 in the illustrated example) for coupling the measurement module 1 to a test bench (not shown) which enable a rapid installation and positional adjustment of the measurement module 1 as well as an easy uncoupling.

In FIG. 7, the sowing element ES is located slightly above the collection means 11 but it could be located at least partially in the internal space of the collection means 11, as represented by the dash-dotted lines in FIG. 7.

In a variant not illustrated, the frame has no support feet but is provided, e.g., with a gripping handle. In this scenario, it is not necessary to set the measurement module on the ground during a test, e.g., in a field, as the measurement module can be attached to the agricultural machine to be tested by suitable attachment means.

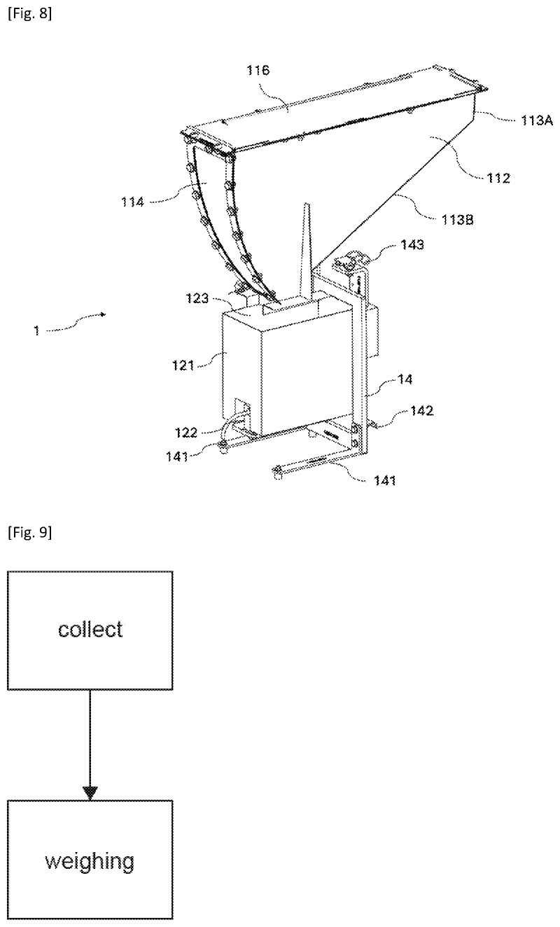

In the example illustrated in FIGS. 7 and 8, the collection means 11 include a collection receptacle 110 for collecting particles that includes an internal space defined by at least one peripheral wall that includes a portion that forms a ramp directed towards the outlet opening.

In the example illustrated in FIGS. 7 and 8, the collection receptacle 110 includes two opposite longitudinal walls 111, 112 connected to each other by a side wall 114 and a bottom wall 113 that are arranged facing each other.

The collection receptacle 110 also includes a particle inlet opening 116 with a first cross section that is capable of collecting particles from the sowing element of the agricultural machine without the receptacle being in contact with the sowing element ES, as well as an outlet opening 117 with a second cross section that is smaller than the first section, wherein the outlet opening 117 is capable of delivering the collected particles to the measurement means 12.

By way of example, the ratio between the first and second cross sections is between 3:1 and 12:1 and is preferably approximately 8:1.

Such a ratio offers several advantages. It advantageously makes it possible for the collection receptacle to be fed with particles from a plurality of separate sowing elements associated with a plurality of hoppers of the agricultural machine. It is thus possible to feed the measurement module simultaneously with a plurality of granular materials to be sown, for example field beans, rapeseed and fertiliser. The large opening also makes it possible to collect all the seeds, which arrive in a turbulent and disordered manner, like a funnel that has a wide enough inlet so as to catch all the seeds.

The measurement module is arranged so that the length of the inlet opening corresponds to the direction of forward movement of the agricultural machine and the width of the inlet opening corresponds to the direction transverse to this direction of forward movement.

In the example illustrated in FIGS. 7 and 8, the bottom wall includes a first flat portion 113A located on the side of the inlet opening 116, which is extended by a second portion 113B that forms a ramp (FIG. 8), which is in turn extended by a third flat portion 113C located on the side of the outlet opening 117 (FIG. 7).

The inlet opening 116 of the collection receptacle 110 has a rectangular cross section here and allows the module to be adapted to different types of sowing elements. A large opening at the top of the collection receptacle 110 enables an adaptation to a maximum range of outlet mechanisms, such as sowing elements, available on the market as well as to the flow of particles without modifying the machine settings recommended by the manufacturer, and makes it possible to receive a plurality of outlets of identical or different particles.

The collection receptacle 110 has a general shape of a funnel, the cross section of which decreases progressively from the particle inlet opening 116 to the particle outlet opening 117. The two opposite longitudinal walls 111, 112 do not extend parallel to each other but become gradually closer as one moves from the inlet opening 116 towards the outlet opening 117.

The walls of the collection receptacle 110 are configured to channel or guide the flow of particles from the inlet opening 116 towards the outlet opening 117 that communicates with the measurement means 12.

The measurement means 12 for measuring a quantity of particles from the collection means 11 belong to the group including:
particle-weighing means, such as a dynamic weighing sensor;
particle-counting means, such as an optical sensor,
means for measuring a volume of a number of particles, such as a flowmeter with a paddle wheel.

In the example illustrated in FIGS. 7 and 8, the measurement means 12 for measuring a quantity of particles include a weighing container 121 and a weighing sensor 122 that is arranged under the weighing container 121 and that is capable of weighing the particles received in the weighing container 121. This enables a precise measurement of the quantity of particles.

In the illustrated example, the weighing container 121 is cuboid in shape. It includes an upper opening 123 capable of collecting particles from the collection receptacle 110. The particles fall by gravity into the weighing container 121. The upper opening 123 extends essentially underneath the outlet opening 117, wherein the gap between these two openings is small so that the measurement module is compact in height. The upper opening 123 of the weighing container 121 is larger than the outlet opening 117.

This measurement module 1, which is portable, can also be used in an autonomous manner to take measurements in the field. In this use case, there is no test bench, but the measurement module 1 is used directly in the field.

The assembly constituted by the collection means 11 and the weighing means 12 is compact due to the relative arrangement of these two separate elements.

The seeds fall by gravity from the collection means 11 into the weighing container 121 as the seeds are discharged by one or more outlets of the seed drill.

The weighing sensor 122 emits a weight measurement signal, which is processed either locally by a processing unit included in the measurement module or remotely, for example in a test bench (the processing unit can be configured to obtain a mass flow-rate signal via a time derivative of a weight measurement from a measurement module).

In this example, the second portion 113B of the bottom wall 113 of the collection receptacle 110 forms a ramp directed towards the outlet opening 117. The angle of inclination of this ramp is less than the angle of inclination of the longitudinal walls 111, 112 and the side wall 114.

The side wall 114 of the collection receptacle 110 has a curved shape here, while the longitudinal walls 111, 112 are flat. This curved shape of the side wall 114 allows the flow of particles exiting the sowing element ES to be directed downwards despite the ejection angle specific to each seed element. It enables an absorption of the kinetic energy of the particles falling onto this curved side wall 114.

In a variant not shown, the side wall 114 of the collection receptacle 110 is flat.

The radius of curvature of the curved side wall 114 is between 1 and 6 m, preferably between 2 and 4 m.

The measurement module is compact in width (less than 20 cm) and length (less than 50 cm), which makes it possible to measure the performance of agricultural machinery like seed drills with narrow clearances. It further has a reasonable weight of around 10 kg. This measurement module 1 is thus easy to use and move in order to carry out a test.

In a particular embodiment, at least part of the peripheral wall is made of a flexible material. In the embodiment described with reference to FIGS. 7 and 8, the curved side wall 114 is made of such a flexible material.

By way of example, the side wall 114 can consist of a net or folded woven material capable of cushioning particles (anti-rebound wall) coming from the sowing element ES.

When the side wall 114 consists of a net, any conveying air present in the flow of particles from the sowing element ES into the collection means 11 can be let out through the mesh of the net, so as not to distort the measurement of the quantity of seeds implemented by the measurement means 12 located downstream of the collection means 11. The mesh of the net is dimensioned so as to keep in the particles and let out the conveying air mixed with the particles.

This curved side wall 114 is preferably a wall with a steep slope so as not to impede the flow of the particles towards the bottom of the collection receptacle 110.

More generally, at least part of the peripheral wall of the collection receptacle 110 can consist of at least one folded flexible element with an undulating surface.

Advantageously, at least one peripheral wall of the collection receptacle 110 can include micro-perforations for the passage of air.

The micro-perforations can be essentially square and preferably have a length between 0.3 and 0.6 mm.

The measurement module 1 includes tilting means 124 (a cylinder in this example) for tilting the particle-weighing container 121 from a position for receiving the particles from the collection receptacle 110 to an emptying position for emptying the weighing container 121. This makes it easy at the end of the weighing operation to empty the weighing container 121 and carry out another measurement if necessary. The weight measurement is interrupted during emptying. Thanks to the cylinder-type tilting means, the weighing container 121 can be emptied remotely (without the intervention of an operator) and according to a procedure that can be automatic.

It is possible to place a plurality of measurement modules side by side and associate each with one or more sowing elements of a seed drill, and to synchronise the weight measurements of a plurality of measurement modules in order to measure the transverse distribution in lines or rows of the seed drill across the working width and establish a performance diagnosis for a seed drill just off the production line or in the field after several hours of use. The measurement of the quantities emitted by the measurement sensors of each module can be transmitted to a processing device separate from the measurement modules, wherein the processing unit can determine a quantity (e.g. weight) of seeds for each of the rows and compare a measured quantity with a theoretical quantity of seeds to be sown for one or more given rows of the seed drill. This makes it possible to verify that each sowing element of the seed drill is functioning correctly and to detect any anomalies or malfunctions affecting one or more sowing elements of the seed drill. This anomaly can be linked to the sowing element being partially or completely blocked, which requires the intervention of an operator.

The measurement module is suitable for measuring quantities of seeds of different sizes and shapes, for example elongated seeds such as barley, oats or wheat; small, elongated seeds such as flax; or small, round seeds such as rapeseed.

Other variants of the measurement module shown in FIGS. 7 to 9 which are not illustrated are described in the following.

The collection receptacle and the weighing container of the measurement module can be of any other shape.

The collection receptacle 110 can have a general shape of a truncated cone, the cross section of which decreases gradually from the particle inlet opening 116 to the particle outlet opening 117.

The collection receptacle 110 can have an upper portion that has a general shape of a truncated cone and a lower portion that generally has a shape of a cylinder.

The walls of the collection receptacle 110 are configured to channel or guide the flow of particles from the inlet opening 116 towards the outlet opening 117 that communicates with the measurement means 12.

The measurement means can take the form of a measuring container with a general shape of a truncated cone.

Although the measurement module of FIGS. 7 to 9 has been described for a seed drill, it is evident that the same approach can be applied to other agricultural machinery.

The measurement module of FIGS. 7 to 9 is suitable in particular, but not exclusively, for measuring the performance of pneumatic and mechanical seed drills.

It is also suitable for measuring the performance of pneumatic fertiliser spreaders which include, in a known manner, a boom equipped with a plurality of outlet mechanisms that are distributed along this boom and that take the form of outlet conduits or pipes that can be equipped with diffusers or spreader paddles.

It is, however, not suitable for measuring the performance of centrifugal spreaders.

It is noted that the measurement module of FIGS. 1 to 6 can include one or more of the features of the collection means 11 and of the measurement means 12 of the measurement module of FIGS. 7 to 9.

The collection receptacle of the measurement module of FIGS. 1 to 6 can thus have a general shape of a funnel, the cross section of which decreases progressively from the particle inlet opening to the particle outlet opening.

The inlet opening of the collection receptacle of the measurement module of FIGS. 1 to 6 can have an essentially rectangular cross section.

This inlet opening can have a rectangular cross section or an oval cross section or a cross section in the shape of a very elongated ellipse with a length-to-width ratio essentially equal to 8:1.

The length of the inlet opening is measured in the direction of forward movement of the agricultural machine and the width of the inlet opening is measured in the direction transverse to this direction of forward movement.

The collection receptacle of the measurement module of FIGS. 1 to 6 can include an internal space defined by at least one peripheral wall that includes a portion that forms a ramp directed towards the outlet opening.

The collection receptacle can include two opposite longitudinal walls connected to each other by a side wall and a bottom wall that includes said portion forming a ramp.

The bottom wall can include a plurality of portions including a portion that forms a ramp.

The angle of inclination of said portion of the bottom wall that forms a ramp can be less than the angle of inclination of the longitudinal walls and said side wall.

### Said Side Wall Can Be Curved.

The radius of curvature of said curved side wall can be between 1 and 6 m, preferably between 2 and 4 m.

At least a part of said at least one peripheral wall can be made of a flexible material.

Said at least one part of said at least one peripheral wall can consist of at least one flexible element with undulating folds.

Said at least one peripheral wall of the collection receptacle can include micro-perforations for the passage of air.

The micro-perforations can be essentially square and preferably have a length between 0.3 and 0.6 mm.

The measurement module of FIGS. 1 to 6 can include tilting means for tilting the measurement means from a position for receiving a quantity of particles from the collection means to a position for emptying said measurement means.

1. A particle-flow measurement module for a test bench that implements at least two measurement modules, wherein said measurement module is configured to be positioned facing at least one outlet mechanism of an agricultural machine for distributing particles so as to receive an entirety of particles delivered by said at least one outlet mechanism, wherein said measurement module comprises:
collector configured to collect the particles from said at least one outlet mechanism of the agricultural machine;
a measurement device configured to measure a quantity of particles from the collector, and
a particle transfer mechanism that links the collector to said measurement device, wherein said particle transfer mechanism is configured to receive the particles flowing in a turbulent manner from the collector and to deliver the particles in a controlled and regular flow to the measurement device.

2. The measurement module according to claim 1, wherein the particle transfer mechanism comprises a rotary gate that includes a plurality of blades that define cells for transporting particles.

3. The measurement module according to claim 2, wherein the blades of said gate are made of a flexible material.

4. The measurement module according to claim 3, wherein the blades of said gate are made of polyurethane with a hardness of between 50 and 90 Shore.

5. The measurement module according to claim 2, including a controller for controlling a rotational speed of the rotary gate.

6. The measurement module according to claim 2, wherein the rotary gate includes a rotor and at least six transport cells for transporting particles, wherein the blades of at least two transport cells are in contact with a stator of the gate during rotation of the gate.

7. The measurement module according to claim 2, wherein a volume of each a transport cell is between 8 and 15cm³.

8. The measurement module according to claim 1, wherein the particle transfer mechanism comprises a hollow element that includes an internal space for receiving particles, wherein said internal space includes a particle inlet opening at one end that is capable of collecting the particles from the collector and an outlet opening at an opposite end that is capable of delivering the particles to the measurement device, wherein the hollow element is configured to move between a shutting position that shuts the outlet opening, in which the particles from the collector are received in the internal space, and a release position that opens the outlet opening so as to release the particles accumulated in the internal space to the measurement device.

9. The measurement module according to claim 8, wherein the hollow element has walls made of a flexible material and capable of deforming so as to shut or open the outlet opening.

10. The measurement module according to claim 1, wherein said collector comprises a collection receptacle for collecting the particles, which includes a particle inlet opening with a first cross section that is capable of collecting the particles from said at least one outlet mechanism of the agricultural machine and an outlet opening with a second cross section that is smaller than the first cross section, wherein the second outlet opening is capable of delivering the particles to the measurement device for measuring a quantity of particles, wherein the collection receptacle comprises walls configured to guide the particles from the inlet opening towards the outlet opening.

11. The measurement module according to claim 10, including at least one sensor for sensing passing particles, which is arranged at the inlet opening of the collection receptacle for collecting particles.

12. The measurement module according to claim 10, wherein the collection receptacle includes an internal space defined by at least one peripheral wall that includes a portion that forms a ramp directed towards the outlet opening.

13. The measurement module according to claim 12, wherein at least a part of said at least one peripheral wall is made of a flexible material.

14. A The measurement module according to claim 12, wherein said at least one peripheral wall of the collection receptacle includes micro-perforations for the passage of air, wherein the micro-perforations are essentially square and have a length between 0.3 and 0.6 mm.

15. A particle-flow measurement module for a test bench that implements at least two measurement modules, wherein said measurement module configured to be positioned facing at least one outlet mechanism of an agricultural machine for distributing particles in order to receive an entirety of particles delivered by said at least one outlet mechanism wherein said measurement module comprises:
a collector arranged to collect particles from said at least one outlet mechanism of the agricultural machine; and
a measuring device arranged to measure a quantity of received particles, wherein the collector is arranged to deliver collected particles to the measurement device.

16. The measurement module according to claim 15, wherein said collector comprises a collection receptacle for collecting the particles, which includes a particle inlet opening with a first cross section that is capable of collecting the particles from said at least one outlet mechanism of the agricultural machine and an outlet opening with a second cross section that is smaller than the first cross section, wherein the second outlet opening is capable of delivering the particles to the measurement device for measuring a quantity of the particles, wherein the collection receptacle comprises walls configured to guide the particles from the inlet opening towards the outlet opening, wherein the collection receptacle includes an internal space defined by at least one peripheral wall that includes a portion that forms a ramp directed towards the outlet opening, wherein said at least one peripheral wall of the collection receptacle includes micro-perforations for passage of air, wherein the micro-perforations are essentially square and have a length between 0.3 and 0.6 mm.
